(19) United States
(12) Patent Application Publication
(10) Pub. No.: US 2010/0081367 A1
(43) Pub. Date: Apr. 1, 2010

(54) Hand/foot rest

(76) Inventor: Hai Tran, Wichita Falls, TX (US)

Correspondence Address: LITMAN LAW OFFICES, LTD., POST OFFICE BOX 41200, SOUTH STATION, ARLINGTON, VA, 22204, US

(21) Appl. No.: 12/285,126

(22) Filed: Sep. 29, 2008

(51) Int. Cl. A45D 29/00; F24F 7/007; A45D 44/00; B08B 15/00

(52) U.S. Cl. 454/63; 454/49

(57) ABSTRACT

The hand/foot rest is a manicure/pedicure aid with integrated cleaning features. The hand/foot rest includes an ergonomic hollow body covered with cushion material, the top of the body defining a rest/work area for the hand or foot, at least one air inlet port to extract dust and fumes or vapor in the work area and an air outlet port adapted to be connected to a vacuum source to evacuate the extracted air. The hand/foot rest is a portable device of various forms that is capable of being configured for nail care facilities of various sizes and layout

### BACKGROUND OF THE INVENTION

1. Field of the Invention

The present invention relates to a manicure/pedicure aid, more specifically, a hand/foot rest having an integrated vacuum cleaning assembly that ensures removal of potential harmful dust and fumes from the working environment.

2. Description of the Related Art

Many establishments that provide manicure and pedicure services generate a substantial amount of dust and fumes from filing of nails and calluses and the chemicals used to paint, lacquer or generally treat the same. This is especially apparent in a popular high volume boutique. These byproducts may not be of great concern to individual customers unless the customer has some high sensitivity to them, but they are a concern to the nail and skin-care technicians because the technicians work in that environment for longer periods of time. Prolonged exposure to the dust and fumes may result in a potential health hazard to the technician. One way to resolve this issue is to provide an air filtration, e.g. vacuum cleaning means, on the work table, but such an arrangement tends to be bulky and not amenable to reconfigurations for a wide range of establishment sizes and layouts.

Thus, a hand/foot rest solving the aforementioned problems is desired.

### SUMMARY OF THE INVENTION

The hand/foot rest includes an ergonomic hollow body covered with cushion material, the top of the body defining a rest/work area for the hand or foot, at least one air inlet port to extract dust and fumes or vapor in the work area and an air outlet port adapted to be connected to a vacuum source to evacuate the extracted air. The hand/foot rest is a portable device that is capable of being adapted to various sizes and layout of nail care facilities.

These and other features of the present invention will become readily apparent upon further review of the following specification and drawings.

### BRIEF DESCRIPTION OF THE DRAWINGS

FIG. 1 is an environmental, perspective view of a hand/foot rest according to the present invention.

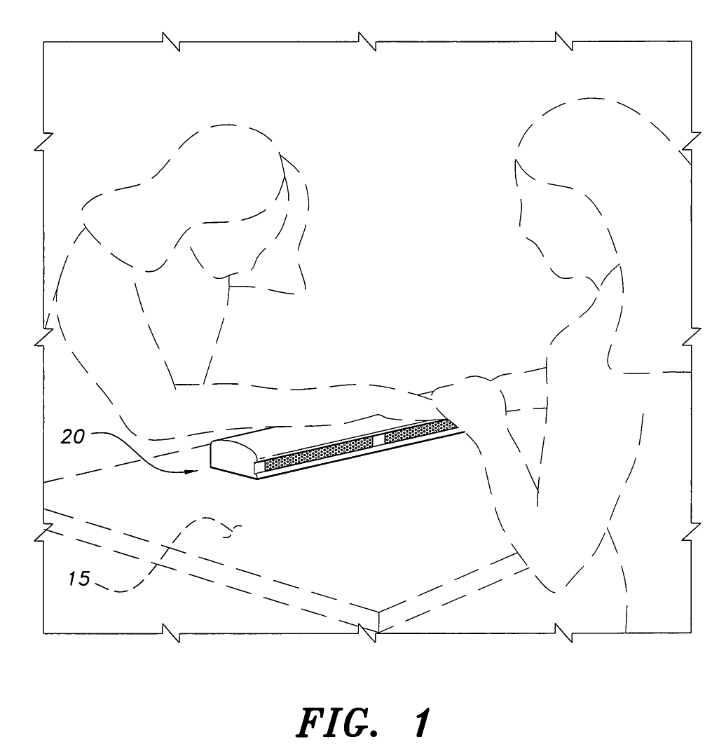

FIG. 2 is a front perspective view of the hand/foot rest according to the present invention.

FIG. 3 is a side sectional view of the hand/foot rest according to the present invention.

FIG. 4 is a side sectional view of an alternative grille arrangement for the hand/foot rest according to the present invention.

FIG. 5 is a front perspective view of an alternative hand/foot rest according to the present invention.

FIG. 6 is a side sectional view of the alternative hand/foot rest of FIG. 5 according to the present invention.

FIG. 7 is a front view of another alternative hand/foot rest according to the present invention.

FIG. 8 is a top view of the alternative hand/foot rest of FIG. 7 according to the present invention.

FIG. 8A is a top view of a further alternative hand/foot rest of FIG. 7 according to the present invention.

FIG. 9 is a side sectional view of the alternative hand/foot rest of FIG. 7 according to the present invention.

FIG. 10 is a front sectional view of the alternative hand/foot rest of FIG. 7 according to the present invention.

FIG. 11 is a cutaway, front perspective view of an alternative hand/foot rest according to the present invention.

FIGS. 12A, 12B, and 12C are diagrams of various work environment configurations for the hand/foot rest according to the present invention.

Similar reference characters denote corresponding features consistently throughout the attached drawings.

### DETAILED DESCRIPTION OF THE PREFERRED EMBODIMENTS

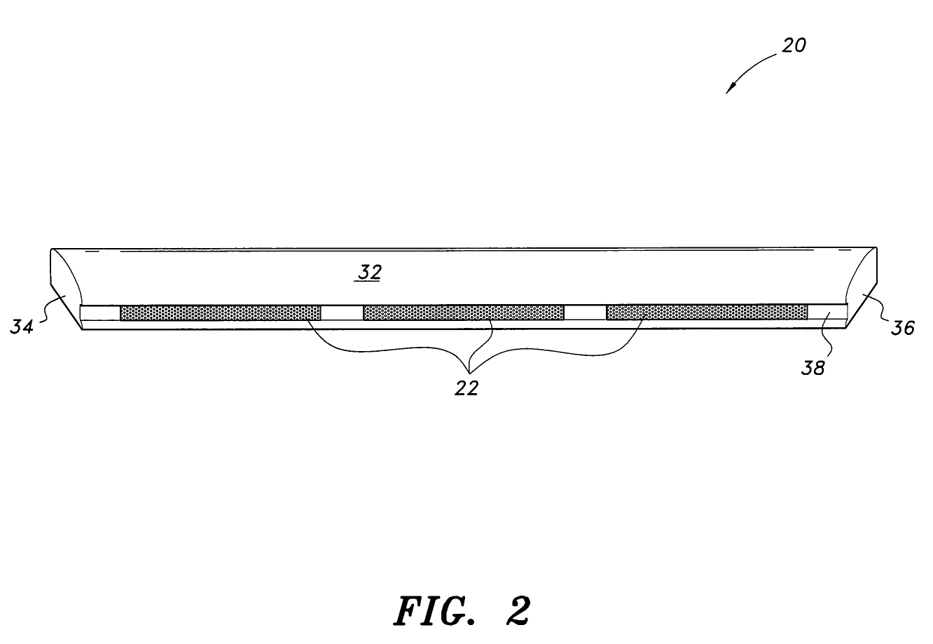

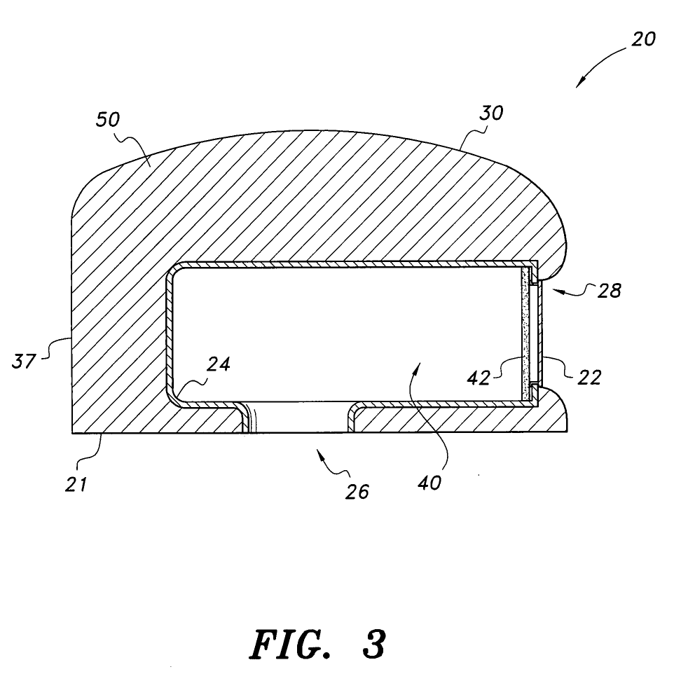

The present invention relates to a hand/foot rest 20 that cleans the working area of dust and fumes/vapor generated during a manicure/pedicure session. As shown in FIGS. 2-3, the hand/foot rest 20 includes an ergonomic, elongate hollow body having a base 21, a contoured top 32 adapted for comfortable placement of a customer's hand or foot, a back 37 which normally faces the customer, inwardly tapered side ends 34, 36 and a recessed front 38 defining space for the air inlet ports 28 described below. The contoured top 32 serves as the work area for the hand/foot rest 20. The base 21 of the hand/foot rest 20 is substantially flat for secure placement on the surface of a work table 15. The hand/foot rest 20 also includes cushion material 50 enclosing the hollow portion of the hand/foot rest 20 to add to the comfort level. The top 32, back 37, side ends 34, 36, and portions of the recessed front 38 not obstructing the inlet ports 28 may be covered by fabric, vinyl, leather or any other types of protective and comfortable material.

The hollow portion of the hand/foot rest includes a substantially rectangular or trapezoid-shaped tubing or lining 24 defining an air chamber 40. A plurality of spaced openings are formed on the front side of the lining 24, and the front of the hand/foot rest also has a plurality of matching spaced openings formed thereon to together define air inlet ports 28. A press-fit grille 22, which may be decorative, covers each of the air inlet ports 28. These grilles 22 are removably mounted to selectively gain access to the air chamber 40 for periodic cleaning and/or maintenance.

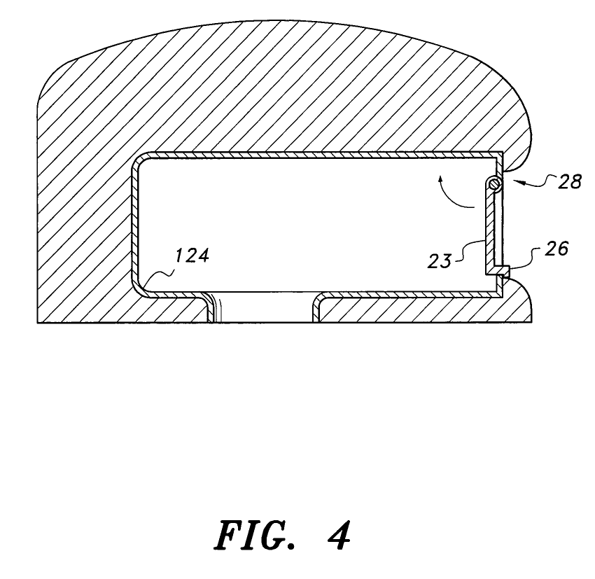

As an alternative, the grilles may be pivotably mounted to the air inlet port 28, an example of which is shown in FIG. 4. FIG. 4 shows a hinged grille 23 pivotably mounted to the air inlet port 28. A lip portion 25 prevents the hinged grille 23 from pivoting into the air chamber 40 while also providing a grip for the user to open the hinged grille 23. The hinged grille 23 may also be biased to insure the hinged grille 23 maintains a closed position. Each of the grilles 22, 23 provide some filtration of the dust particles, but to insure a higher level of filtration, a filter 42 may be provided behind each of the grilles and inside the air chamber. At least one air outlet port 26 is preferably formed on the bottom side of the lining 24. However, the at least one air outlet port 26 may be disposed at the back 37 and/or side ends 34, 36 of the hand/foot rest 20. The air outlet port 26 is adapted to be connected to a vacuum source to extract the polluted air. To maximize airflow during use, the air outlet port 26 is not disposed on the same side as the air inlet port 28.

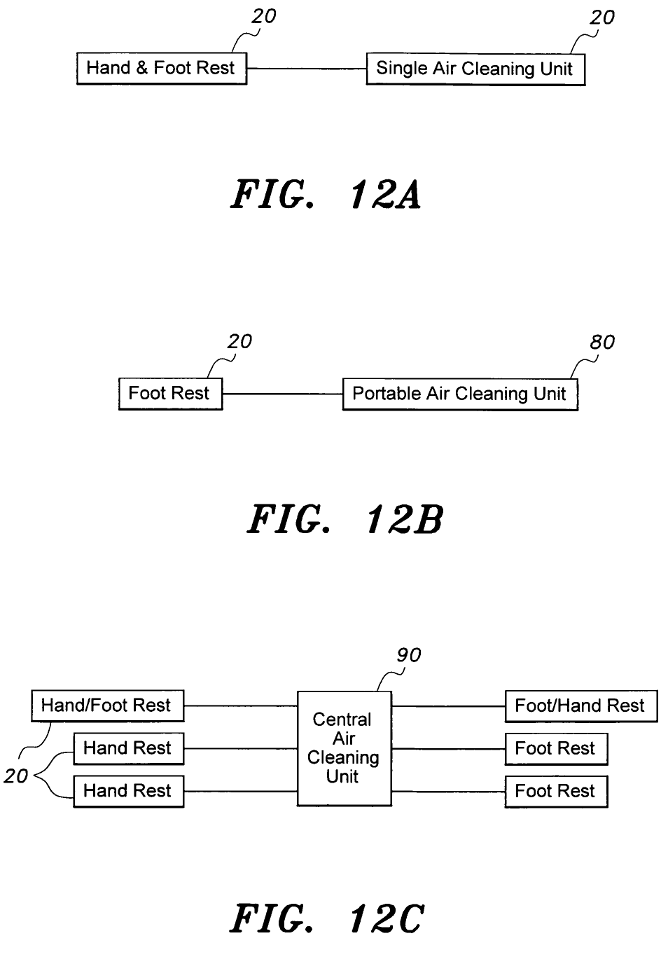

Regarding the vacuum source, a variety of different vacuum sources may be employed to operate with the hand/foot rest 20. As mentioned previously, the hand/foot rest is configured to be portable and adaptable for placement in various sized facilities and work station layouts. To facilitate such configurations, the vacuum sources may include a single air cleaning unit 70, a portable air cleaning unit 80 and/or central air cleaning unit 90. In a small facility with a single work station, the hand/foot rest 20 may be connected to the single air cleaning unit 70 which may be disposed under the work station table. (See FIG. 12A.) In situations where house calls are necessary or portability is desired, the portable air cleaning unit 80 may be employed in conjunction with the hand/foot rest 20. (See FIG. 12B.) In a larger facility containing a plurality of workstations, the central air cleaning unit 90 may be used to connect to a plurality of hand/foot rests 20 as schematically shown in FIG. 12C. The above arrangements of-the vacuum sources apply to the other embodiments discussed further below, and any combination of vacuum sources may be employed as desired or needed by the user. Moreover, each of the above vacuum sources would include a self filtration system or means, so that the inclusion of the filter 42 in the hand/foot rest 20 would increase the effect of filtering dust.

To operate the hand/foot rest 20, the nail care technician insures that the hand/foot rest 20 is operably connected to one of the vacuum sources mentioned above. The customer's hand or foot is then placed on the contoured top 32 to commence work on the customer's nails, and the technician insures that the nail being worked is near the grille. Vacuum is initiated to extract the dust and fumes generated during the work. To clean the interior of the hand/foot rest 20, the technician would pull the grille 22 out of engagement with the air inlet port 28 to access the air chamber 40. In the case of the hinged grille 23, the technician may grip the lip 25 to pull the hinged grille 23 out of engagement with the air inlet port 28.

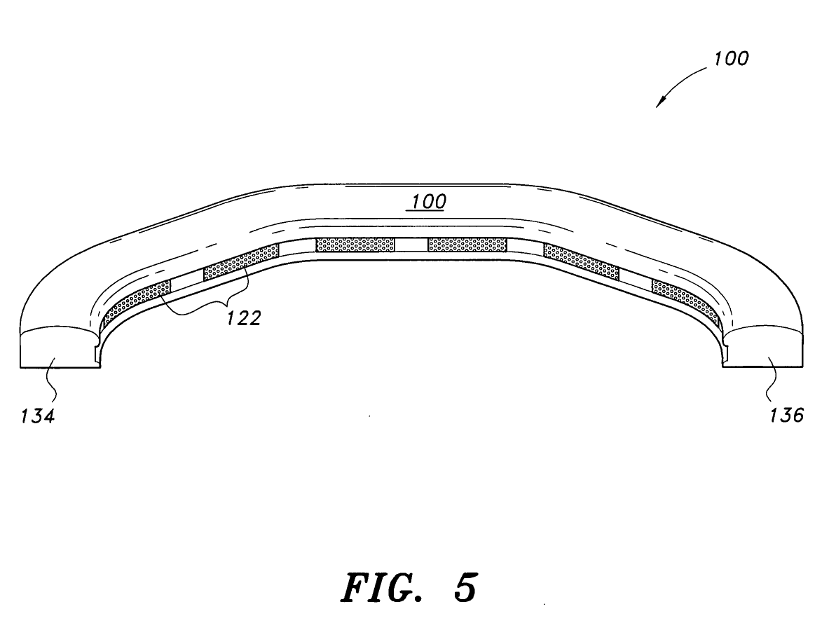

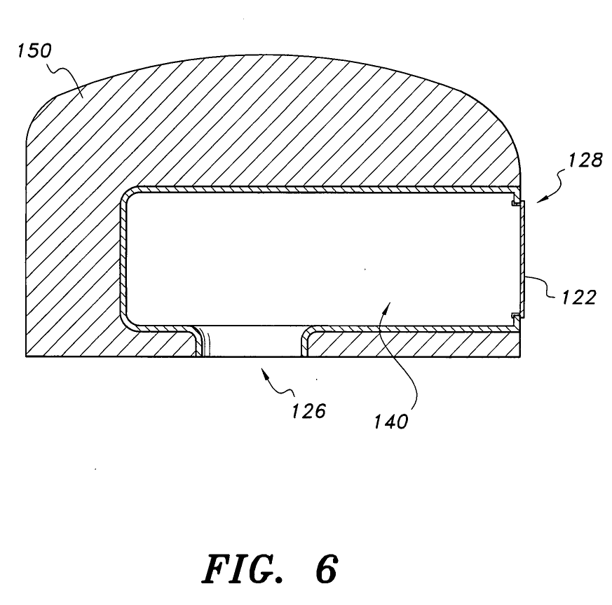

FIGS. 5 and 6 refer to a second embodiment of the hand/foot rest. The second hand/foot rest 100 includes many similar features as the first embodiment such as a contoured top 102, side ends 134, 136, a plurality of spaced grilles 122 disposed in respective air inlet ports 128, a tubular lining 124 defining an air chamber 140, cushion material 150 surrounding the lining 124 and at least one air outlet port 126. In this embodiment, the hand/foot rest 100 is substantially curved subtending an arc about 1800. As shown in FIG. 6, the hand/foot rest 100 may be wider than the first embodiment and the grilles 122 may be disposed more flush with the front. The work area defined by the contoured top 102 is now expanded so that multiple tasks may be performed at the same time. For example, a customer's hand/foot may rest on one side of the hand/foot rest 100, e.g. adjacent the end 136, while the other hand/foot is being worked by the technician on the other side of the hand/foot rest 100, e.g. adjacent the end 134. Moreover, the finished hand/foot may rest on the respective side to permit the nails to dry with assistance from the vacuum through the grilles 122. This embodiment of the hand/foot rest may subtend an arc greater or lesser than 180°, as long as the expanded work area is maintained.

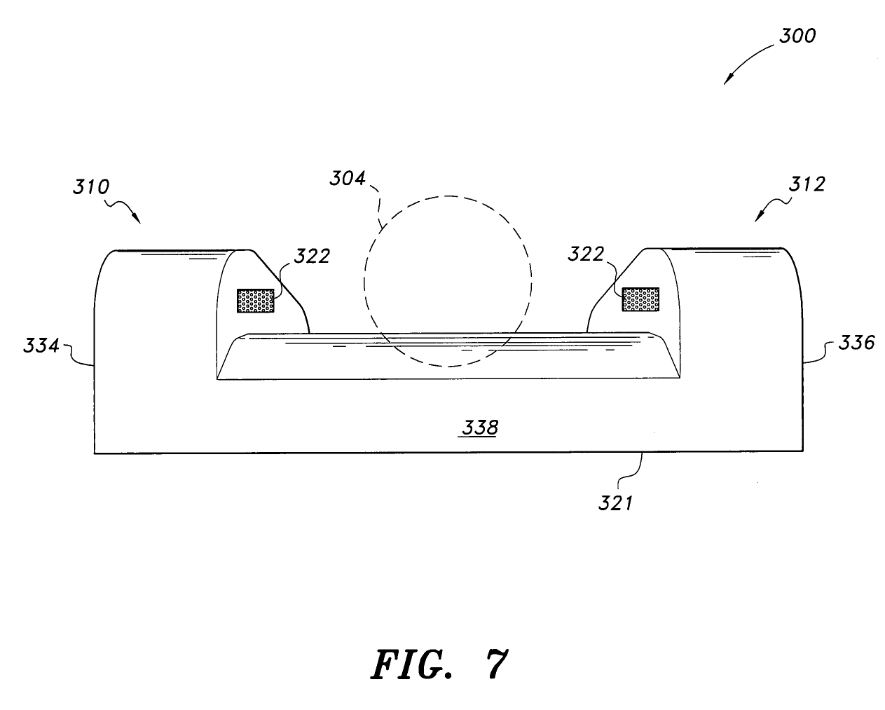

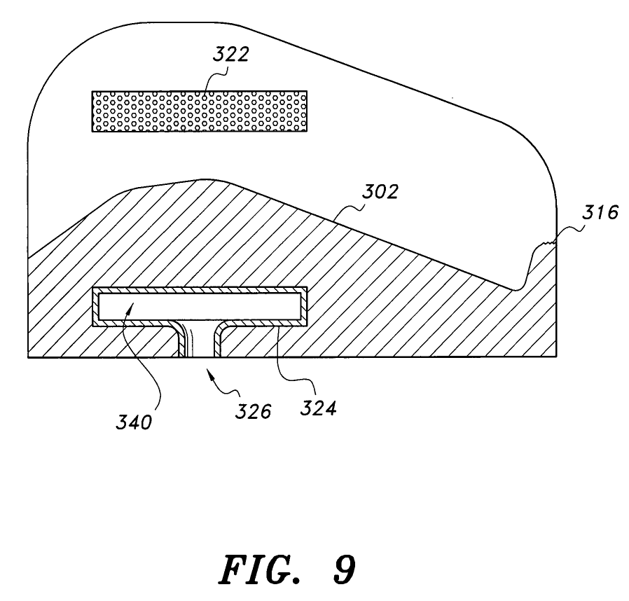

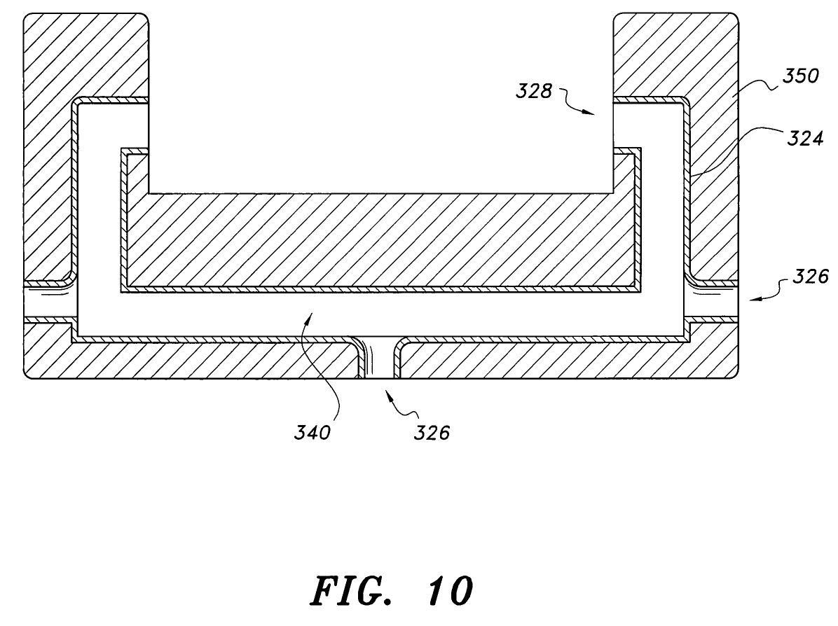

FIGS. 7-10 refer to third and fourth embodiments of the hand/foot rest. In this embodiment, the hand/foot rest 300 includes a substantially U-shaped body when viewed from the front 338 thereof. The two legs of the U-shape project upwardly from opposite side ends 334, 336 of the hand/foot rest 300 to a predetermined height, and the top of the legs slope inwardly and downwardly toward the back 327 to form first and second discrete rests 310 and 312. A portion of the top surface of the first and second discrete rests 310 and 312 is textured to form first and second resting areas 311, 312 for a customer's hand or foot. A contoured or profiled work section 302 is formed between the first and second discrete rests 310, 312 to define a work area 304 so that the technician may work on one hand or foot of a customer while the other hand or foot is resting on either of the discrete rests 310, 312. The work section 302 is disposed at a height about midway of the discrete rests 310, 312, and the contour thereof substantially parallels the shape of the discrete rests when the hand/foot rest 300 is viewed from the side as shown in FIG. 9. The front 327 of the hand/foot rest 300 includes an upwardly extending projection forming a support bar 316 for the forearm or heel of a customer.

As with the previous embodiments, the third embodiment hand/foot rest 300 is hollow, and the air chamber 340 is defined by a network of tubing or lining 324 that substantially conform to the shape of the hand/foot rest 300. Each of the discrete rests 310, 312 includes at least one air inlet port 328 facing each other toward the work section 302, and they are respectively covered by a grille 322. A plurality of air outlet ports 326 is formed in the tubing 324 to extract the polluted air. The tubing is covered by cushion material 350 to define the shape of the hand/foot rest 300.

In this embodiment, operation of the hand/foot rest 300 is substantially the same as that of hand/foot rest 100 with the exception that the discrete rests 310, 312 clearly define locations to place the extremity not being worked. In addition, the projecting support bar 316 increases the comfort of the customer by reducing possible strain that may occur from an unsupported forearm or heel.

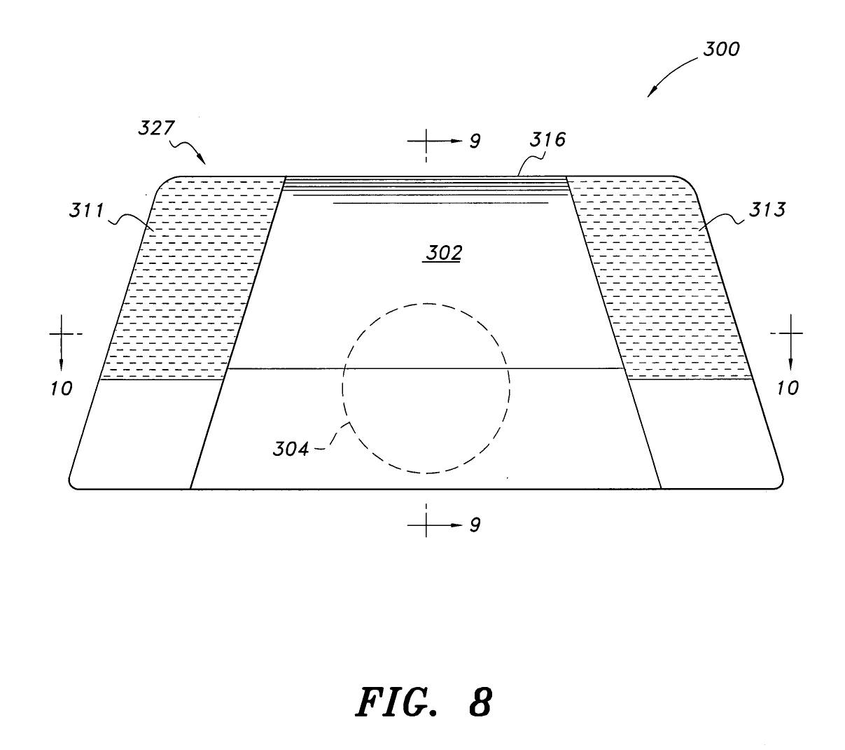

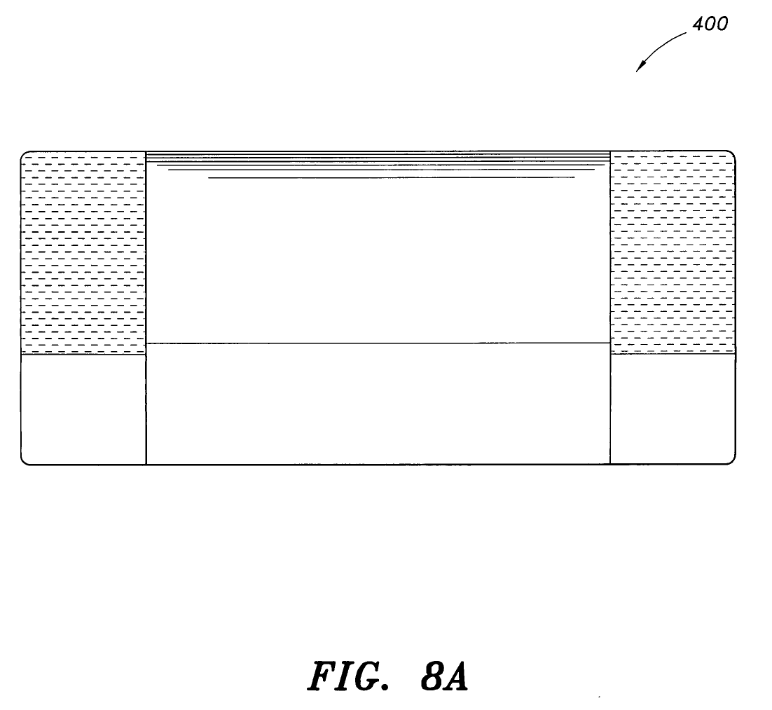

Referring to FIG. 8A, the fourth embodiment hand/foot rest 400 is another variation of the hand/foot rest 300. The hand/foot rest 400 includes the same functional elements as the hand/foot rest 300 except that it is rectangular shaped as compared to the trapezoidal shape of the hand/foot rest 300 shown in FIG. 8.

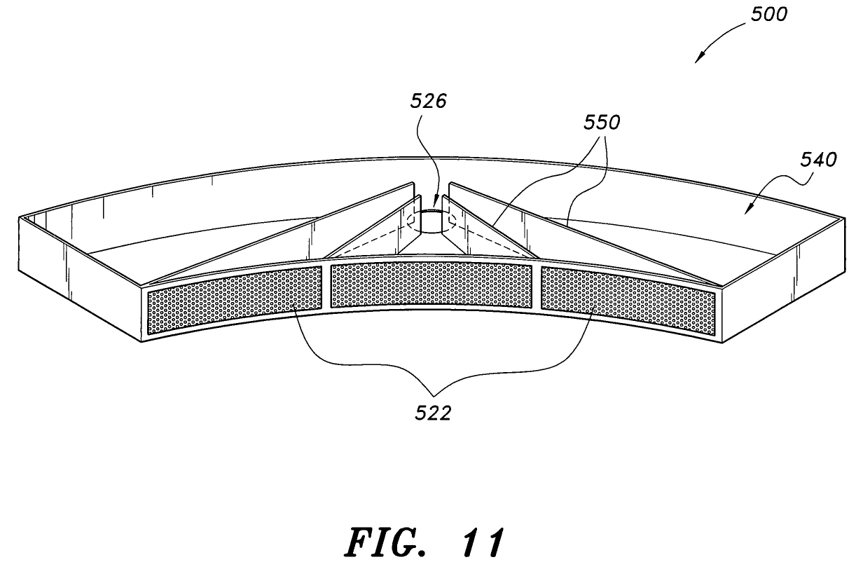

A fifth embodiment of the hand/foot rest is shown in FIG. 11. The hand/foot rest 500 is disclosed without the top. In this embodiment, the air chamber 540 includes an airflow control mechanism. The airflow control mechanism includes a plurality of baffles 550 extending from the air inlet ports (at the grilles 522) towards the air outlet port 526. These baffles 550 direct the airflow from the air inlet ports to the air outlet port 526 for optimal cleaning and vacuum performance.

It is noted that the hand/foot rest, in all its embodiments, may encompass a variety of alternatives to the various features thereof. For example, the baffles 550 in the hand/foot rest 500 may be operatively applied to the other embodiments. The cushion material may be made from synthetic or natural sponge-like material of varying density and resilience. The tubing may be made from steel sheeting, plastic or wood that can be shaped to form the desired air chamber and maintain airflow integrity. The contour of the top of the hand/foot rest may also be changed to vary the ergonomic comfort level.

It is to be understood that the present invention is not limited to the embodiments described above, but encompasses any and all embodiments within the scope of the following claims.

I claim:

1. A hand/foot rest, comprising:
a contoured hollow body having a top, a flat bottom, a front, a back and side ends, the top defining a work area and adapted for placement of a person's hand/foot, the bottom adapted for placement on a workstation surface, the hollow of the body including a tubular lining defining an air chamber;
a plurality of spaced air inlet ports disposed in the front of the body;
a plurality of grilles respectively mounted on the air inlet ports;
at least one air outlet port adapted to connect to a vacuum and operatively disposed on a side away from the air inlet ports; and
a vacuum source connected to the at least one air outlet port;
wherein dust and fumes generated during a manicure/pedicure session may be extracted with vacuum through the air inlet and outlet ports.

2. The hand/foot rest according to claim 1, further comprising a cushion material enclosing said lining and defining the shape of the body.

3. The hand/foot rest according to claim 2, further comprising a covering for the body, the covering being made a material selected from the group consisting of fabric, vinyl or leather.

4. The hand/foot rest according to claim 1, further comprising a plurality of hinges, each of said grilles being pivotally mounted on the respective air inlet port by one of the hinges.

5. The hand/foot rest according to claim 1, further comprising a filter disposed behind each of the grilles.

6. The hand/foot rest according to claim 1, wherein said vacuum source is selected from the group consisting of an air cleaning unit, a portable air cleaning unit and a central air cleaning unit.

7. The hand/foot rest according to claim 1, further comprising an airflow control system disposed in the air chamber to control and optimize airflow to clean the polluted air.

8. The hand/foot rest according to claim 7, wherein the airflow control system comprises a plurality of baffles extending from each of the air inlet ports toward the at least one air outlet port.

9. The hand/foot rest according to claim 1, wherein said body extends in a substantial curve to increase the work area.

10. The hand/foot rest according to claim 9, wherein said curve subtends an arc of about 180°.

11. The hand/foot rest according to claim 9, wherein said curve subtends an arc less than 180°.

12. The hand/foot rest according to claim 9, wherein said curve subtends an arc of greater than 180°.

13. A hand/foot rest comprising:
a substantially U-shaped hollow contoured body, the body having a top, a flat bottom, a front, a back and side ends, the hollow of the body including a tubular lining conforming to the shape of the body and defining an air chamber;
first and second discrete rests upwardly extending from respective side ends forming the U-shaped body, the discrete rests being adapted for a user to place an extremity thereon;
a profiled working section disposed between the first and second discrete rests, the working section defining a work area for a technician to work on the user's extremity;
an upwardly projecting support bar adapted to support the user's forearm or heel;
at least one air inlet port disposed on each of the first and second discrete seats, the at least one air inlet ports facing the working section;
a plurality of grilles respectively mounted on the air inlet ports;
at least one air outlet port adapted to connect to a vacuum and operatively disposed on a side away from the air inlet ports; and
a vacuum source connected to the at least one air outlet port;
wherein dust and fumes generated during a manicure/pedicure session may be extracted with vacuum through the air inlet and outlet ports.

14. The hand/foot rest according to claim 13, further comprising a cushion material enclosing said lining.

15. The hand/foot rest according to claim 14, further comprising a plurality of hinges, each of said grilles being pivotally mounted on the respective air inlet port by one of the hinges.

16. The hand/foot rest according to claim 14, further comprising a filter disposed behind each of the grilles.

17. The hand/foot rest according to claim 13, wherein said vacuum source is selected from the group consisting of an air cleaning unit, a portable air cleaning unit and a central air cleaning unit.

18. The hand/foot rest according to claim 14, further comprising an airflow control system disposed in the air chamber to control and optimize airflow to clean the polluted air.

19. The hand/foot rest according to claim 18, wherein the airflow control system comprises a plurality of baffles extending from each of the air inlet ports toward the at least one air outlet port.
